(19) United States
(12) Patent Application Publication
(10) Pub. No.: US 2002/0142765 A1
(43) Pub. Date: Oct. 3, 2002

(54) Network appliance wireless configuration interface

(76) Inventor: Monte J. Rhoads, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/823,386

(22) Filed: Mar. 30, 2001

(51) Int. Cl. H04M 3/00

(52) U.S. Cl. 455/419; 455/420; 455/424

(57) ABSTRACT

A network appliance with a wireless interface for receiving wireless signals from a wireless device, where the signals contain the network appliance's configuration information, is disclosed. A wireless device with signal generating, coding and transmitting capabilities allows a user to send coded signals containing configuration information to a network appliance. A network appliance with a wireless signal interface receives the signals, decodes them, converts them to machine-accessible information to configure the network appliance, and stores the information in memory. The configuration information can be displayed, either on the network appliance or the wireless device, to confirm that configuration is correct.

### FIELD OF THE INVENTION

The invention relates to the wireless programming of the configuration information of a network appliance.

### BACKGROUND OF THE INVENTION

In a computer network, a server is a computer that performs services requested by other computers called clients. In order for a client to send a request to the particular server that can provide the services requested, the server must have a network address, for example, an Internet Protocol (IP) address.

A server may be equipped with an input device, such as an alphanumeric keyboard or keypad, for communicating information and command selections to the server. In addition, a server may be equipped with a display device, such as a video monitor or a liquid crystal display (LCD), to show both input to the server and output by the server. If a server is not equipped with an input device or a display device, the user must couple the input device or display device to the server. A server that is equipped with a display device and an input device, or is otherwise self-contained, in that it does not need any external device coupled to it, is called an appliance.

A common type of appliance is a 1U rack-mounted appliance, which is 1.75″ tall, and has arrow keypads and an LCD on its front panel, which are used to program the appliance's IP address. FIG. 1 illustrates a 1U rack-mounted appliance. To program the IP address, the up-down arrow keypads are used to scroll through numbers until the first number of the IP address appears in the LCD. Once the correct number appears, the right arrow keypad is used to enter the number and move to the next position in the IP address. Programming is complete once this process is repeated for each number of the IP address.

The current method of programming a network appliance's IP address is difficult for the following reasons. First, multiple 1U rack-mounted appliances may have to be programmed at the same time. A typical seven-foot rack can hold up to 42 1U rack-mounted appliances, some of which are located at the bottom of the rack, only a few inches off the floor, while others are located at the top of the rack, almost seven feet above the floor. Thus, it can be difficult to reach the appliances' arrow keypads to program their IP addresses. In addition, because a 1U rack-mounted appliance is only 1.75″ tall, the viewable area of its LCD is relatively small, as is the font of the numbers that appear in the LCD. Accordingly, the numbers that appear in the LCD can be difficult to read under ideal circumstances, when the appliance is at eye level. The numbers can be even more difficult to read considering where some of the appliances are located on a rack. In particular, for appliances located above or below eye level, the angle of viewing changes as the eyes move toward the top or bottom of the rack, which makes the LCDs more difficult to read. Consequently, to see the LCDs of appliances located at other than eye level, a person must change the viewing angle by physically moving up toward the ceiling, or down toward the floor.

### BRIEF DESCRIPTION OF THE DRAWINGS

The invention is illustrated by way of example, and not by way of limitation, in the figures of the accompanying drawings in which like reference numerals refer to similar elements.

FIG. 1 is a drawing of a 1U rack-mounted appliance that has arrow keys for inputting configuration information.

FIG. 2a is a drawing of a 1U rack-mounted appliance that has a wireless interface for inputting configuration information.

FIG. 2b is a block diagram of a network appliance that has an interface which receives configuration information via infrared (IR) signals from a wireless device equipped with an IR signal transmitter.

FIG. 2c is a block diagram of the network appliance in FIG. 2b, but which has a cover for concealing the wireless interface.

FIG. 2d is a block diagram of a network appliance that has an interface which receives configuration information via radio frequency (RF) signals from a wireless device equipped with an RF signal transmitter.

FIG. 3 is a flow diagram of a method of receiving configuration information from a wireless device.

FIG. 4 is a flow diagram of a technique that causes a wireless device to transmit configuration information to a wireless interface of a network appliance.

### DETAILED DESCRIPTION

A network appliance (e.g., a rack-mounted appliance) with a wireless interface to receive signals containing the appliance's configuration information (e.g., its IP address) from a wireless device equipped with a transmitter, is described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Generally, methods and apparatuses for programming the configuration information (e.g., an IP address) of a network appliance (e.g., a rack-mounted appliance), using a wireless device to transmit signals to a wireless interface, are described. The signals are then converted to machine-accessible information for configuring the appliance. Finally, the configuration information is stored in the appliance's memory, and can be displayed to confirm that configuration is correct.

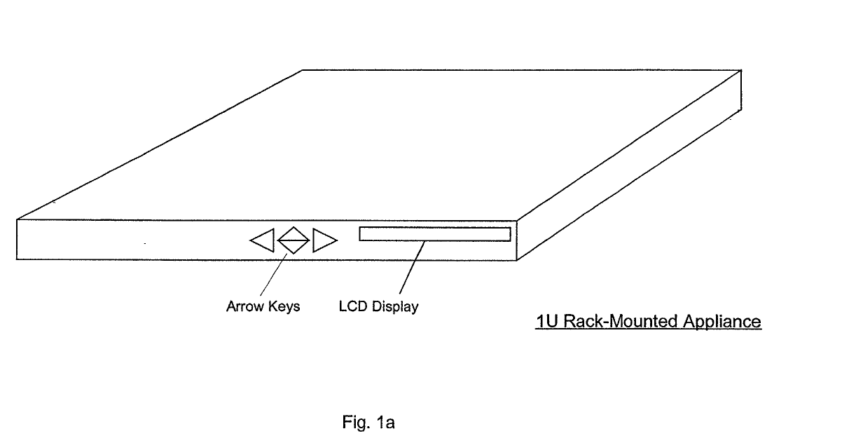

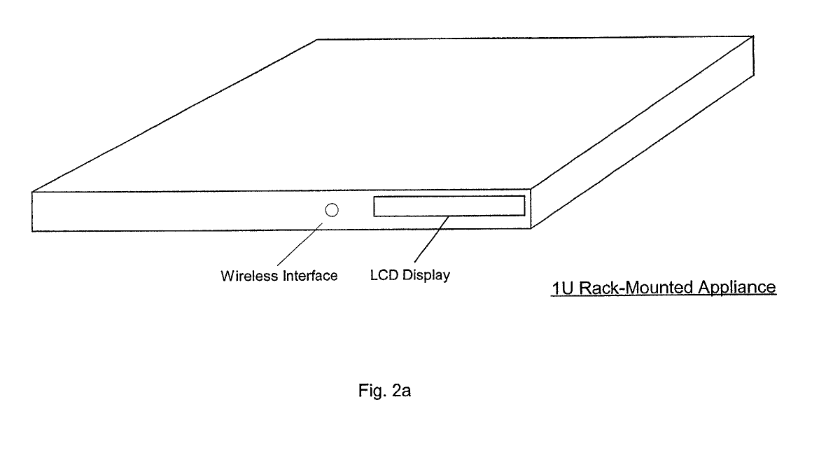

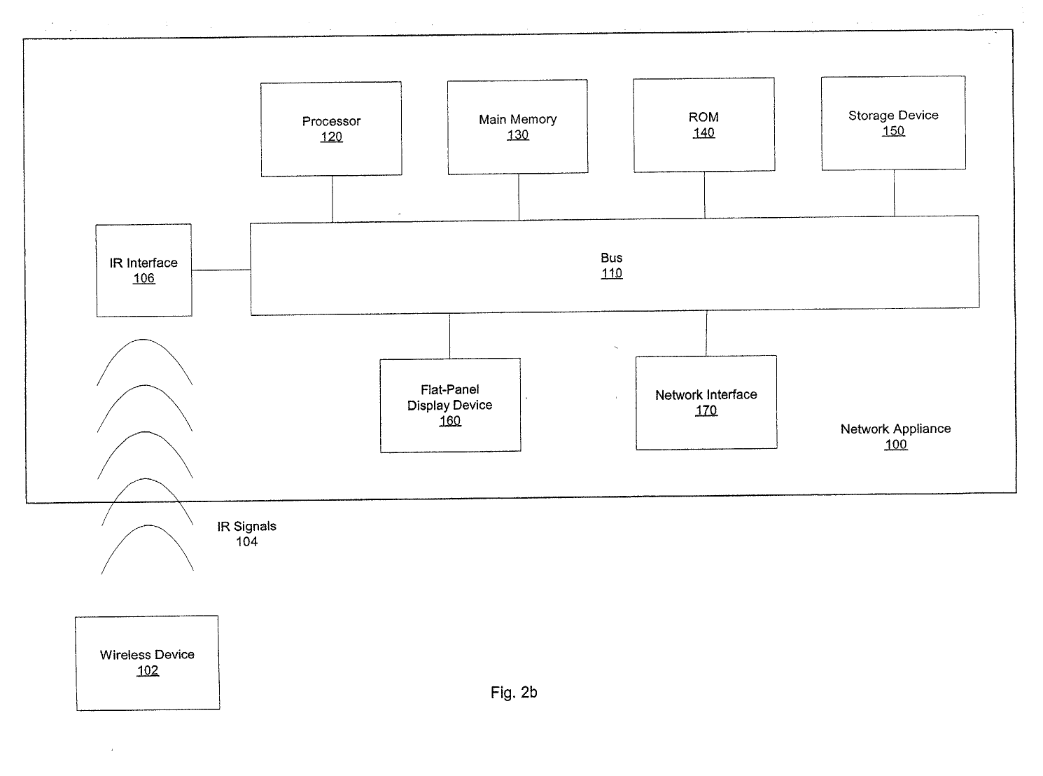

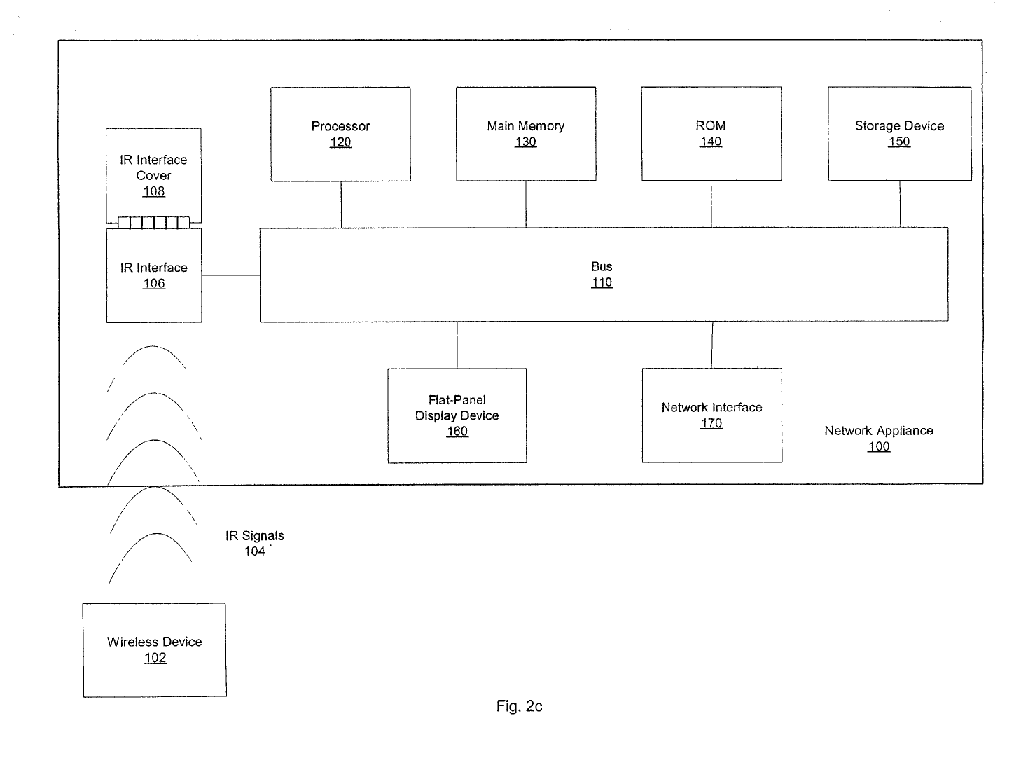

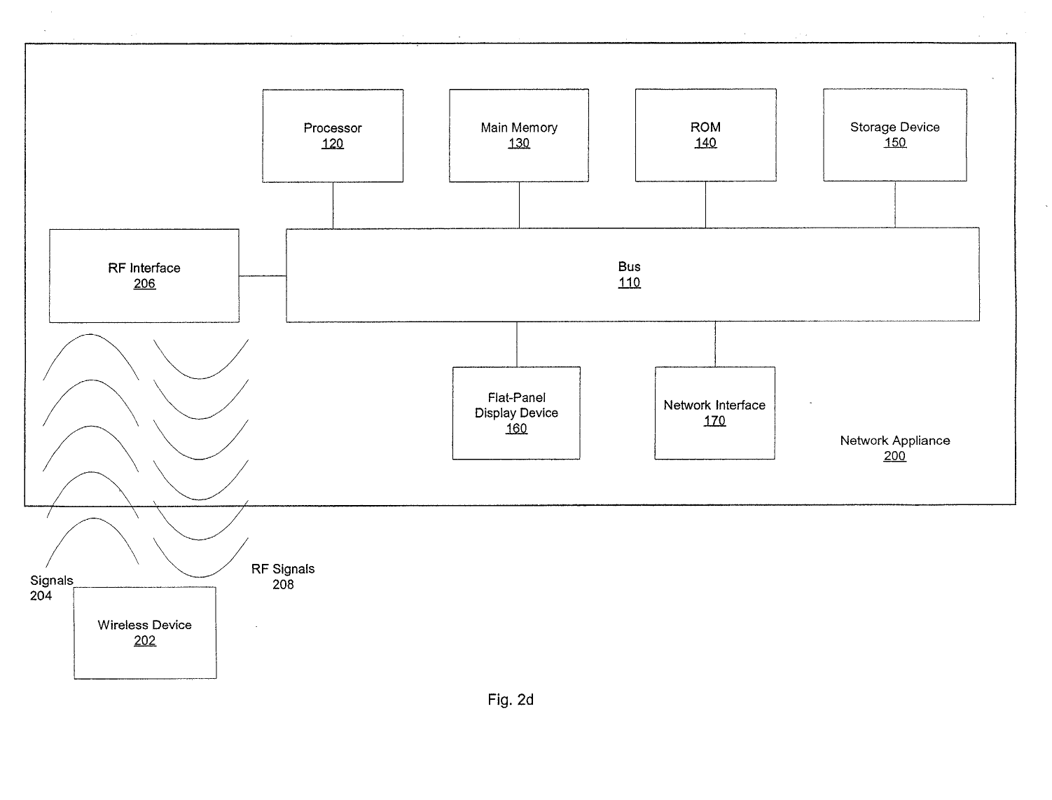

FIG. 2a is a drawing of a 1U rack-mounted appliance that has a wireless interface for inputting configuration information. The wireless interface has replaced the arrow keys shown in FIG. 1.

FIG. 2b is a block diagram of one embodiment of a network appliance (e.g., a rack-mounted appliance) capable of receiving IR signals containing configuration information (e.g., an IP address) from a wireless device.

Network appliance 100 includes an IR interface 106 capable of receiving IR signals 104 from wireless device 102. IR signals 104 are then converted to machine-accessible information for configuring network appliance 100. The configuration information is stored in main memory 130, or other storage element, and can be displayed, for example, on flat-panel display device 160, to confirm that configuration is correct.

Network appliance 100 includes bus 110 or other communication device to communicate information. Bus 110 encompasses all buses that may be present in a computer system, e.g., a memory bus, an Accelerated Graphics Port (AGP) bus, a Peripheral Component Interconnect (PCI) standard bus, an Industry Standard Architecture (ISA) bus, etc. Processor 120 is coupled to bus 110 to process information, and while network appliance 100 is illustrated with a single processor, network appliance 100 can include multiple processors and/or co-processors. Network appliance 100 further includes random access memory (RAM) or other dynamic storage device 130 (referred to as main memory), coupled to bus 110 to store information and instructions to be executed by processor 120. Main memory 130 also can be used to store temporary variables or other intermediate information while processor 120 is executing instructions.

Network appliance 100 also includes read-only memory (ROM) and/or other static storage device 140 coupled to bus 110 to store static information and instructions for processor 120. Data storage device 150 is coupled to bus 110 to store information and instructions. Data storage device 150, such as a magnetic disk or optical disc and corresponding drive, can be coupled to network appliance 100.

Network appliance 100 can also be coupled via bus 110 to flat-panel display device 160, such as an LCD, a vacuum florescent display, an electroluminescent display, etc., to display information to a user. Network appliance 100 further includes network interface 170 to provide access to a network, such as a local area network.

Instructions are provided to memory from a storage device, such as a magnetic disk, a ROM integrated circuit, a CD-ROM, a DVD, via a remote connection (e.g., over a network via network interface 170) that is either wired or wireless, etc. In alternative embodiments, hard-wired circuitry can be used in place of or in combination with software instructions to implement the present invention. Thus, the present invention is not limited to any specific combination of hardware circuitry and software instructions.

A machine-accessible medium includes any mechanism that provides (i.e., stores and/or transmits) information in a form readable by a machine (e.g., a computer). For example, a machine-accessible medium includes ROM; RAM; magnetic disk storage media; optical storage media; flash memory devices; electrical, optical, acoustical or other form of propagated signals (e.g., carrier waves, infrared signals, digital signals); etc.

Network appliance 100 may be any network appliance, e.g., a 1U rack-mounted appliance, a 2U rack-mounted appliance, etc. In one embodiment, network appliance 100 is a 1U rack-mounted appliance. Although one embodiment comprises a network appliance, any network device can be used, e.g., a server, a printer, a copier or a facsimile machine.

Wireless device 102 may be any device capable of generating, encoding and transmitting IR signals. In one embodiment, wireless device 102 is a personal digital assistant (PDA). A PDA is a small mobile hand-held device that provides computing and information storage and retrieval capabilities for personal or business use. Most PDAs, which are often used to provide immediate access to appointment and address book information, have a small keyboard. The name of one of the popular PDA products, for example, a Palm Pilot VII (Palm VII) available from Palm, Inc. of Santa Clara, California, is often used as a generic term for a PDA. Although a PDA is described, any device, e.g., a dedicated remote control, a laptop or palmtop computer, or a cellular phone, that can generate, encode and transmit IR signals, can be used.

IR interface 106 is a wireless interface capable of receiving IR signals 104 from wireless device 102. In one embodiment, IR interface 106 is an IR diode sensor. When IR interface 106 receives IR signals 104 from wireless device 102, IR signals 104 are decoded, then converted to machine-accessible information for configuring network appliance 100. The configuration information is then stored in main memory 130.

In one embodiment, after being stored in main memory 130, the configuration information can be displayed at network appliance 100 on flat-panel display device 160, such as an LCD, to confirm that configuration is correct. LCD technology, which is often used in small computers, displays images by using current to control the luminance of pixels laid out in a grid. In an alternative embodiment, after storage of the configuration information in main memory 130, network appliance 100 transmits IR signals containing the configuring information, back to wireless device 102. The configuration information can be displayed on wireless device 102, to confirm that configuration of network appliance 100 is correct.

FIG. 2c is a block diagram of the network appliance in FIG. 2b, but with IR interface cover 108 concealing IR interface 106.

IR interface cover 108 can be any material (e.g., plastic) of a size and shape large enough to cover IR interface 106. In one embodiment, IR interface cover 108 is a flip-open cover that is attached to network appliance 100 via a hinge above, below or to the side of IR interface 106. In another embodiment, IR interface cover 108 is a slide-open cover that resides in slots above, below or to the side of IR interface 106.

Before transmitting IR signals 104 to network appliance 100, IR interface cover 108 is moved to expose IR interface 106, so that IR signals 104 are transmitted to the particular network appliance 100 whose configuration information is contained in IR signals 104. Consequently, configuration information can be transmitted to the correct appliance, rather than to another appliance with an exposed IR interface.

FIG. 2d is a block diagram of the network appliance in FIG. 2b, except that the appliance in FIG. 2d is capable of receiving configuration information via RF signals, rather than IR signals.

In FIG. 2d, network appliance 200 includes RF interface 206, to receive RF signals 204 from wireless device 202. Network appliance 200 can also include an RF signal transmission system (not shown in FIG. 2d) for generating and encoding RF signals 208, which are transmitted to wireless device 202. RF interface 206 and the RF transmission system of network appliance 200 can be a single device, e.g., a transceiver. Thus, network appliance 200 can receive RF signals 204 and convert them to machine-accessible information for configuring network appliance 200. After network appliance 200 is configured, network appliance 200 can generate and encode RF signals 208 that contain its configuration information, and transmit RF signals 208 to wireless device 202.

Wireless device 202 can be any wireless device capable of generating, coding, transmitting, receiving and decoding RF signals. In one embodiment, wireless device 202 is a PDA with transmitting and receiving capabilities. In addition to a PDA, wireless device 202 can be, among other things, a dedicated remote control, a laptop or palmtop computer or a cellular telephone. In addition, these devices can be Bluetooth-enabled, meaning they can contain Bluetooth technology that allows them to establish a wireless connection at short distances with other Bluetooth-enabled devices, via a radio link in the 2.4 GHz frequency band. Bluetooth-enabled devices can then transmit and receive packets of information at one of the frequencies in the 2.4 GHz band, and hop to a new frequency in the band after transmitting or receiving information. Information regarding Bluetooth technology is available in “Specification of the Bluetooth System: Core,” Volume 1, Doc. No. 1.C.47/1.0B, Bluetooth Special Interest Group, published Dec. 1, 1999.

After network appliance 200 receives RF signals 204 and converts them to machine-accessible information for configuring network appliance 200, network appliance 200 can transmit RF signals 208 that contain the configuration information, back to wireless device 202. Wireless device 202 can then receive RF signals 208 and convert them to machine-accessible information that can be displayed on wireless device 202, to confirm that configuration of network appliance 200 is correct. Because network appliance 200 contains a flat-panel display device 160, configuration information from network appliance 200 can be displayed on flat-panel display device 160 in addition to displaying the information on wireless device 202, or in lieu of displaying the information on wireless device 202. If configuration information from network appliance 200 is displayed on flat-panel display device 160, network appliance 200 does not need to be capable of transmitting RF signals 208, and wireless device 202 does not need to be capable of receiving RF signals 208.

RF interface 206 is a wireless interface that can receive RF signals 204 from wireless device 202. When RF interface 206 receives RF signals 204 from wireless device 202, RF signals 204 are converted to machine-accessible information for configuring network appliance 200, and stored in main memory 130. In one embodiment, RF interface 206 is an antenna.

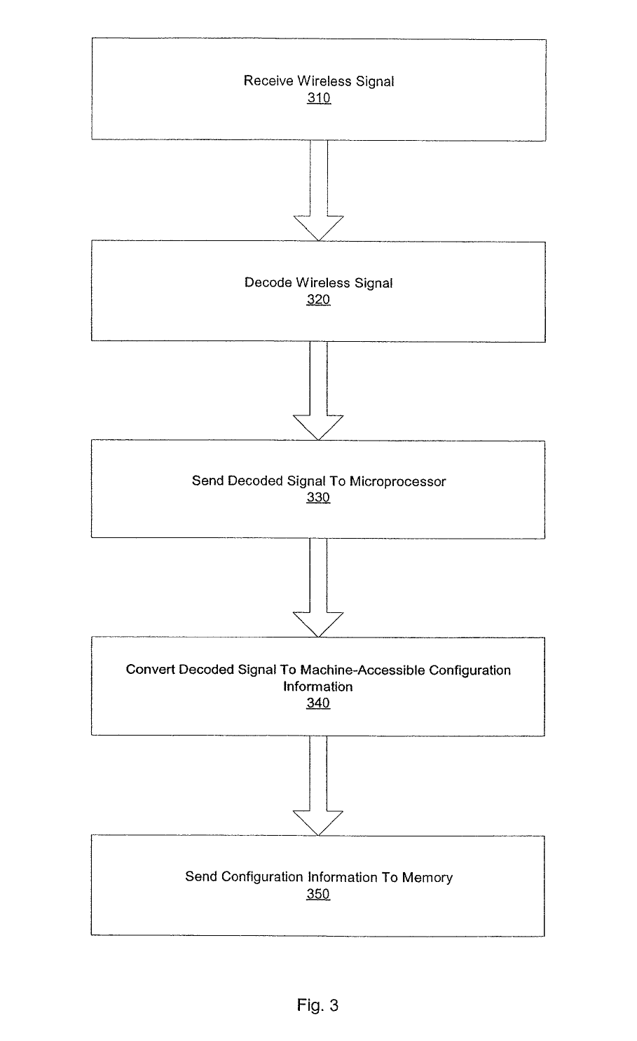

FIG. 3 is a block diagram of a method of receiving signals containing configuration information from a wireless device, and converting the signals to machine-accessible information. At 310, a network appliance receives wireless signals containing configuration information. At 320, the signals are decoded, and at 330, the decoded signals are sent to the network appliance's microprocessor. At 340, the decoded signals are converted to machine-accessible information for configuring the network appliance, and at 350, the configuration information is stored in the network appliance's memory.

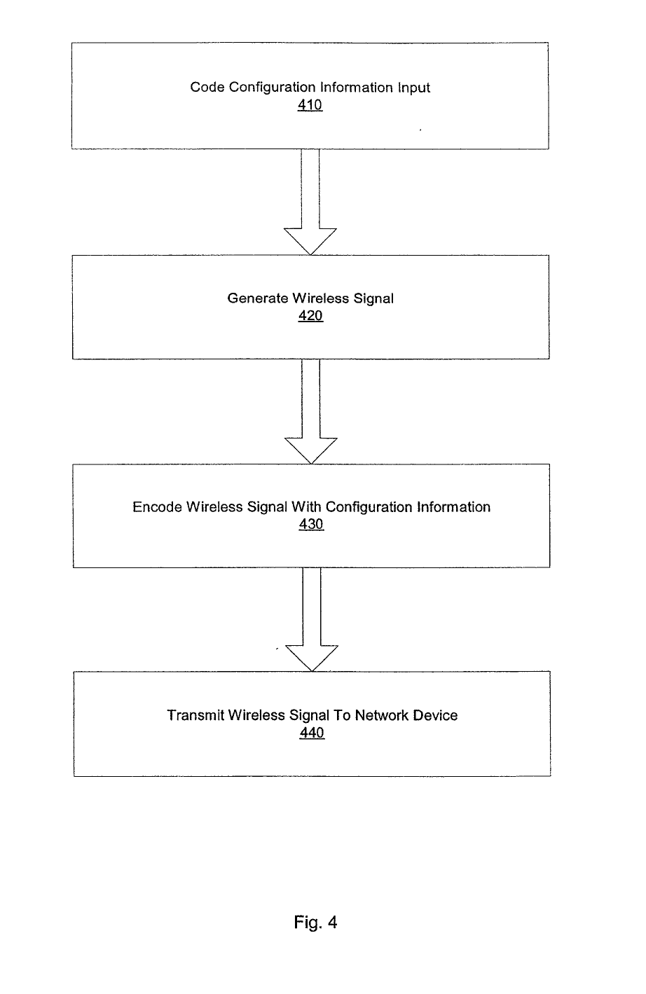

FIG. 4 is a block diagram of a technique that causes a wireless device to send signals containing configuration information to a wireless interface of a network appliance. For example, a PDA could use the technique to allow a user to input the IP address of a network appliance. The technique would then cause the PDA to code the input information at 410, generate IR signals at 420, and encode the IR signals with the IP address at 430. Finally, at 440, the technique would allow the user to use the PDA to transmit the coded signals to the IR interface of the network appliance. Although a PDA using IR signals to transmit an IP address to a network appliance is described, a similar technique can be used to cause any wireless device (e.g., a laptop or palmtop computer, or a cellular telephone) to generate any type of signals (e.g., radio frequency signals), encode the signals with any configuration information (e.g., a buffer value), and transmit the signals to any wireless interface (e.g., an antenna) of any network device (e.g., a server, a printer, a facsimile machine, a copier or a client).

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

What is claimed is:

1. A network appliance comprising:
a wireless interface to receive wireless signals containing the network appliance's configuration information; and
a network interface to receive network information.

2. The apparatus of claim 1, wherein the network appliance further comprises a rack-mounted appliance.

3. The apparatus of claim 1, wherein the configuration information further comprises an Internet Protocol address.

4. The apparatus of claim 1, wherein the wireless signals are generated by a personal digital assistant (PDA).

5. The apparatus of claim 1, wherein the wireless signals further comprise infrared signals.

6. The apparatus of claim 1, wherein the wireless interface further comprises an infrared interface.

7. The apparatus of claim 1, wherein the network appliance further comprises a wireless interface cover.

8. The apparatus in claim 1, wherein the network appliance further comprises a liquid crystal display (LCD).

9. The apparatus of claim 1, wherein the wireless signals further comprise radio frequency signals.

10. The apparatus of claim 1, wherein the wireless interface further comprises a radio frequency interface.

11. The apparatus in claim 1, wherein the network appliance further comprises a radio frequency transmitter.

12. A method for converting wireless signals to machine-accessible information for configuring a network appliance, comprising:
receiving wireless signals containing configuration information from a wireless device;
decoding the wireless signals;
sending the decoded signals to the network appliance's microprocessor;
converting the decoded signals to machine-accessible configuration information; and
storing the configuration information in the network appliance's memory.

13. The method of claim 12, wherein the network appliance further comprises a device capable of receiving and decoding an infrared signal.

14. The method of claim 12, wherein the network appliance further comprises a device capable of receiving and decoding a radio frequency signal.

15. The method of claim 12, wherein the wireless device further comprises a device capable of generating, coding and transmitting an infrared signal.

16. The method of claim 12, wherein the wireless device further comprises a device capable of generating, coding and transmitting a radio frequency signal.

17. The method of claim 12, wherein the wireless signals further comprise infrared signals.

18. The method of claim 12, wherein the wireless signals further comprise radio frequency signals.

19. The method of claim 12, wherein the configuration information further comprises an Internet Protocol address.

20. An article comprising a machine-accessible medium having stored thereon sequences of instructions that, when executed, cause a wireless device to:
code a network appliance's configuration information input to the wireless device;
generate a wireless signal;
encode the wireless signal with the configuration information; and
transmit the encoded signal to the network appliance.

21. The machine-accessible medium of claim 20, wherein the wireless transmitter further comprises a device that can generate, encode and transmit an infrared signal.

22. The machine-accessible medium of claim 20, wherein the wireless transmitter further comprises a device that can generate, encode and transmit a radio frequency signal.

23. The machine-accessible medium of claim 20, wherein the wireless signal further comprises an infrared signal.

24. The machine-accessible medium of claim 20, wherein the wireless signal further comprises a radio frequency signal.

25. The machine-accessible medium of claim 20, wherein the configuration information further comprises an Internet Protocol address.
